(19) United States
(12) Patent Application Publication
(10) Pub. No.: US 2025/0365714 A1
(43) Pub. Date: Nov. 27, 2025

(54) MULTI-BAND BANDWIDTH PART (BWP) FOR A VIRTUAL CELL

(71) Applicant: QUALCOMM Incorporated, San Diego, CA (US)

(72) Inventors: Kazuki TAKEDA, Tokyo (JP); Kianoush HOSSEINI, San Diego, CA (US); Jing LEI, San Diego, CA (US); Heechoon LEE, San Diego, CA (US)

(21) Appl. No.: 18/674,061

(22) Filed: May 24, 2024

(51) Int. Cl. H04W 72/0453; H04W 72/51

(52) U.S. Cl. CPC H04W 72/0453; H04W 72/51

(57) ABSTRACT

Certain aspects of the present disclosure provide a method for wireless communications at a user equipment (UE). The UE may receive one or more configurations of one or more bandwidth parts (BWPs) of a virtual cell. The virtual cell may be configured with a plurality of frequency bands and each BWP may indicate contiguous frequency resources in the plurality of frequency bands. The UE may process one or more downlink and uplink transmissions, in accordance with the received configurations.

### BACKGROUND

### Field of the Disclosure

Aspects of the present disclosure relate to wireless communications, and more particularly, to techniques for configuring uplink and downlink bandwidth parts (BWPs) of a virtual cell.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes receiving one or more configurations of one or more bandwidth parts (BWPs) of a virtual cell, wherein the virtual cell is configured with a plurality of frequency bands and each BWP indicates contiguous frequency resources in the plurality of frequency bands; and processing one or more transmissions, in accordance with the received configurations.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIG. 4A, FIG. 4B, FIG. 4C, and FIG. 4D depict various example aspects of data structures for a wireless communications network.

FIG. 5 depicts example aggregated bandwidth of a virtual cell.

FIG. 6 depicts example uplink bandwidth part (BWP) and a downlink BWP in a paired spectrum operation.

FIG. 7 depicts example uplink BWP and a downlink BWP in an unpaired spectrum operation.

FIG. 8 depicts a call flow diagram illustrating example communication among different wireless nodes for managing configurations of BWPs of a virtual cell.

FIG. 9 depicts example configurations of downlink BWPs of a virtual cell.

FIG. 10 depicts example table showing a set of sub-bands and/or frequency bands for a virtual cell for downlink operations.

FIG. 11 depicts a first example of configurations of a downlink BWP and an uplink BWP of a virtual cell.

FIG. 12 depicts a second example of configurations of a downlink BWP and an uplink BWP of a virtual cell.

FIG. 13 depicts a third example of configurations of a downlink BWP and an uplink BWP of a virtual cell.

FIG. 14 depicts a fourth example of configurations of a downlink BWP and an uplink BWP of a virtual cell.

FIG. 15 depicts example time gap between scheduled uplink transmissions.

FIG. 16A depicts a fifth example of configurations of a downlink BWP and an uplink BWP of a virtual cell.

FIG. 16B depicts example time gap between scheduled uplink and downlink transmissions.

FIG. 17 depicts example configurations of downlink BWPs and uplink BWPs of a virtual cell.

FIG. 18 depicts a method for wireless communications at a wireless node such as a UE for managing configurations of BWPs of a virtual cell.

FIG. 19 depicts example communications device managing configurations of BWPs of a virtual cell.

### DETAILED DESCRIPTION

Aspects of the present disclosure provide apparatuses, methods, processing systems, and computer-readable mediums for configuring uplink and downlink bandwidth parts (BWPs) of a virtual cell (e.g., for 6th generation (6G) systems), which is different from a physical cell (e.g., for 5th generation (5G) systems).

A BWP generally refers to a contiguous set of resource blocks (RBs) on a given carrier. Each BWP may be associated with different parameters such as a subcarrier spacing (SCS), a symbol duration, and a cyclic prefix (CP) length. BWPs may be allocated for downlink and uplink operations. For example, a user equipment (UE) may be configured with multiple separate downlink BWPs for the downlink operations and uplink BWPs for the uplink operations.

A physical cell for 5G systems is associated with one of multiple frequency bands. For 6G systems aiming for a better user experience and overall performance than the 5G systems, a virtual cell may be used that is associated with multiple non-contiguous sub-bands or frequency bands. The virtual cell may enable improved utilization efficiency of frequency resources for the uplink/downlink operations due to use of the multiple non-contiguous sub-bands or frequency bands.

The virtual cell may include (or is associated with) a lowest frequency associated with a lowest sub-band to a highest frequency associated with a highest sub-band. There may be one or multiple parameters/factors to form the virtual cell, such as: a frequency range (e.g., the virtual cell may contain the multiple sub-bands belonging to a same frequency range), a frequency gap of two adjacent sub-bands (e.g., the frequency gap is less than or equal to a pre-configured/determined threshold), an aggregated bandwidth (e.g., the aggregated bandwidth across all the sub-bands is less than or equal to a pre-configured/determined threshold), and a numerology (e.g., all the sub-bands may use a same SCS and CP length).

Techniques described herein define BWP configurations for a virtual cell that is formed by multiple frequency bands. For example, a downlink BWP of the virtual cell may include a number of contiguous frequency bands that may enable reception of downlink transmissions. In another example, the downlink BWP of the virtual cell may include a number of non-contiguous frequency bands that may enable the reception of the downlink transmissions.

The techniques described herein further define association between the downlink BWPs and the uplink BWPs for the virtual cell. For example, a set of frequency bands for the uplink operations for the virtual cell may not need to be the same as that for the downlink operations for the same virtual cell.

Particular aspects of the subject matter described in this disclosure can be implemented to realize one or more of the following potential advantages. In some examples, the described techniques may facilitate new and contiguous spectrum with good coverage and better utilization of the frequency resources for the downlink/uplink operations.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

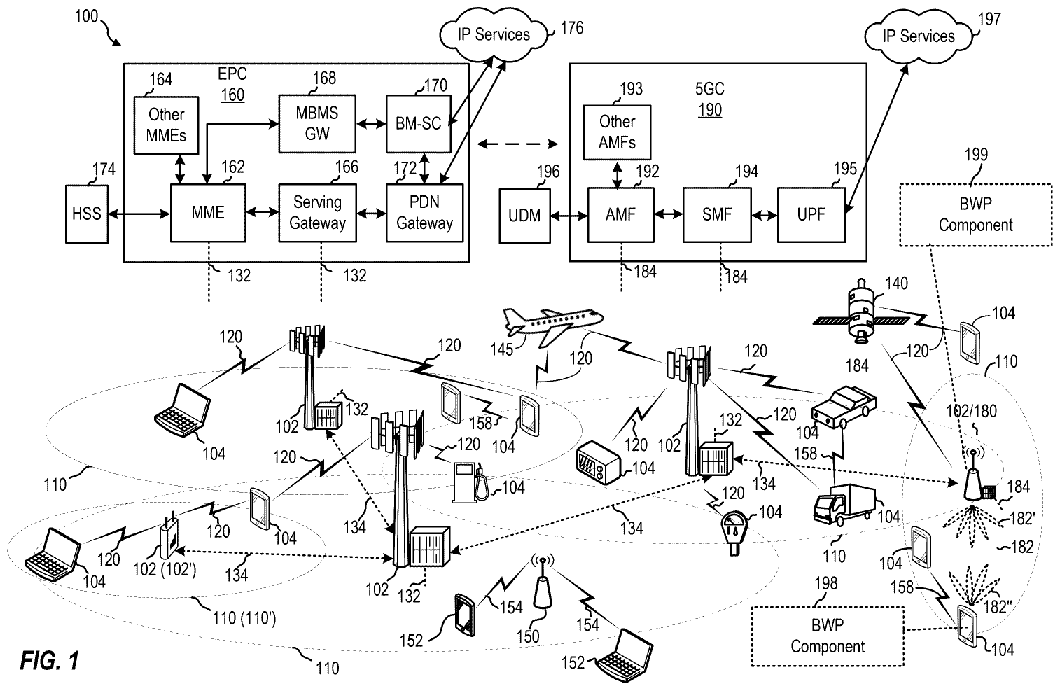

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

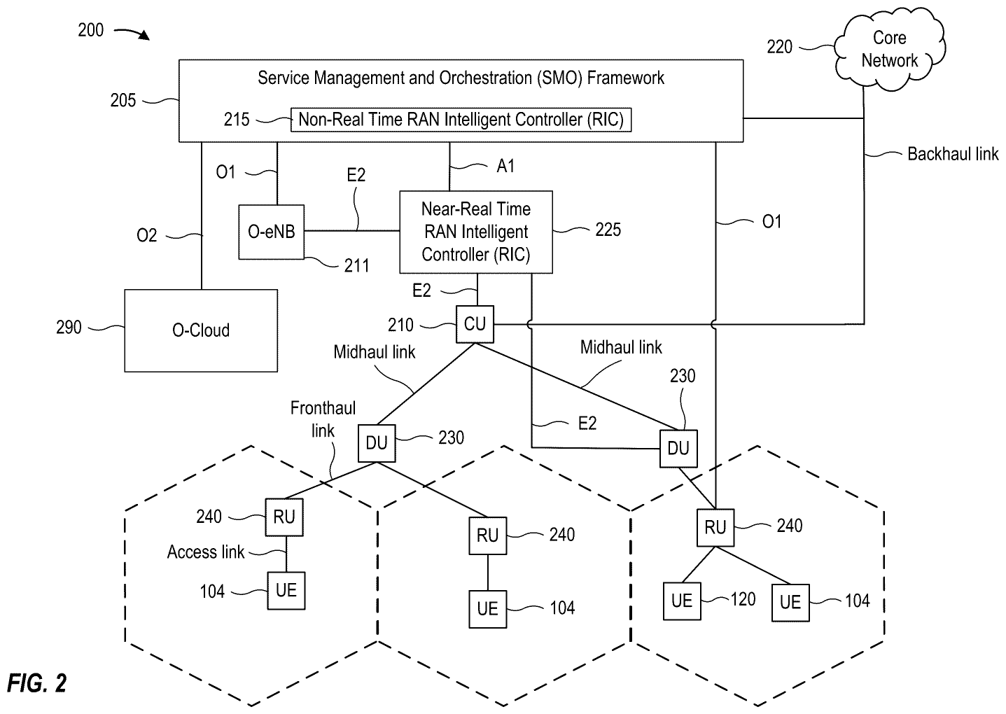

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHZ-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mm Wave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

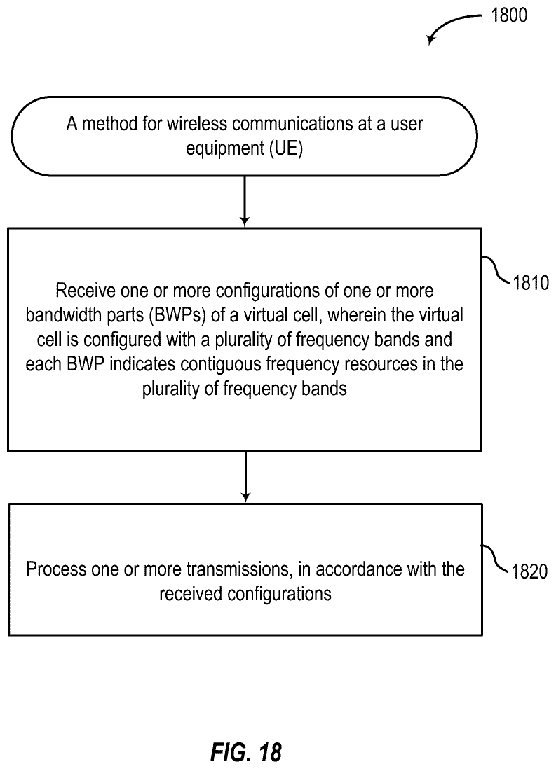

Wireless communication network 100 further includes bandwidth part (BWP) component 198, which may be configured to perform method 1800 of FIG. 18. Wireless communication network 100 further includes BWP component 199, which may be configured to perform method 1800 of FIG. 18.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 245, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

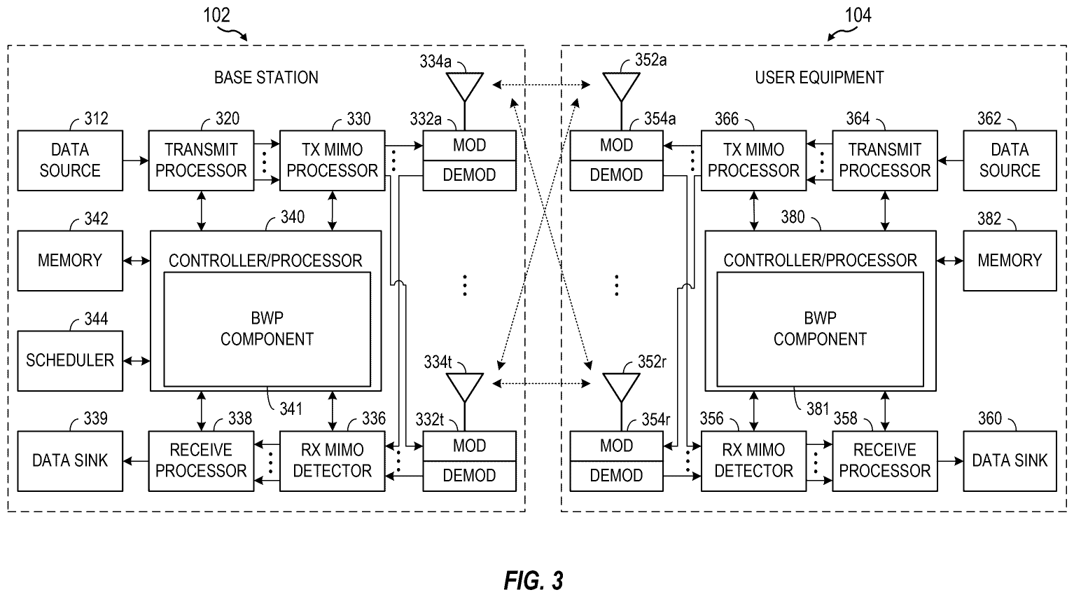

FIG. 3 depicts aspects of an example BS 102 and a UE 104.

Generally, BS 102 includes various processors (e.g., 324, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes BWP component 341, which may be representative of BWP component 199 of FIG. 1. Notably, while depicted as an aspect of controller/processor 340, BWP component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes BWP component 381, which may be representative of BWP component 138 of FIG. 1. Notably, while depicted as an aspect of controller/processor 380, BWP component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the SRS). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of providing or outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

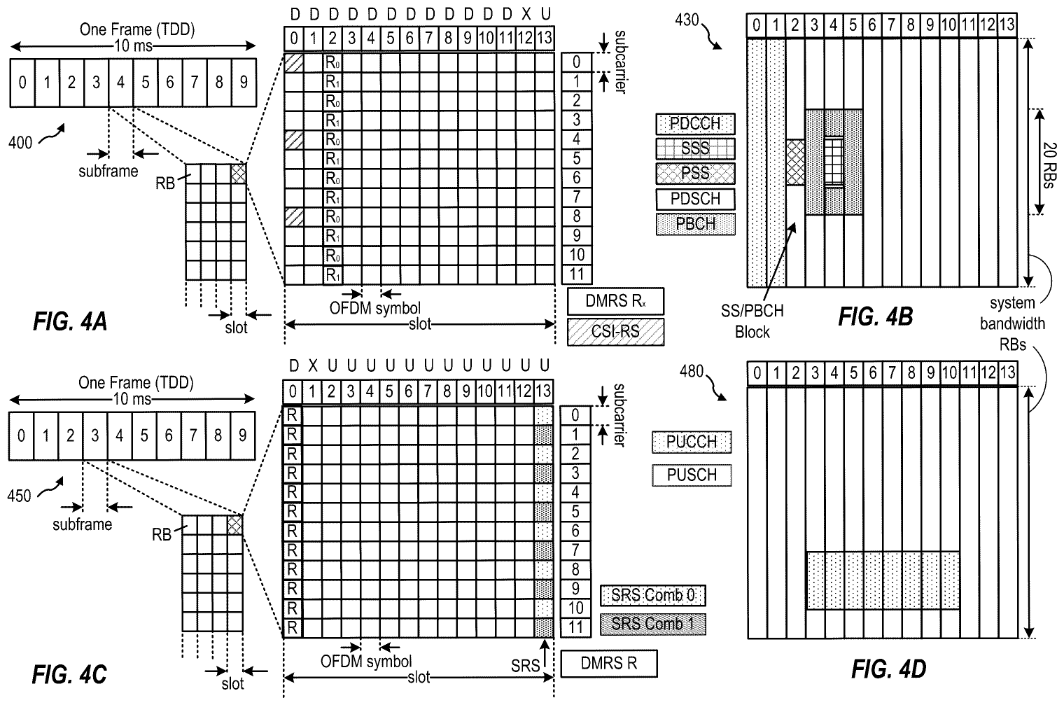

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 5. As such, the numerology u=0 has a subcarrier spacing of 15 kHz and the numerology u=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology u=2 with 4 slots per subframe. The slot duration is 0.25 ms, the subcarrier spacing is 60 kHz, and the symbol duration is approximately 16.67 us.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mm Wave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR1) as including 600 MHZ-6 GHz, though specific uplink and downlink allocations may fall outside of this general range. Thus, FRI is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mm Wave/near mm Wave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of System Bandwidth in Long Term Evolution (LTE) and 5^{th} Generation (5G) Systems

In current systems, for a cell site with one or multiple component carriers (CCs) or cells, a system bandwidth of each CC may span a set of resource blocks (RBs) contiguous in frequency, which may be lower bounded by a minimum channel bandwidth (CBW) of a user equipment (UE). A value of the minimum CBW of the UE may be radio access technology (RAT)-dependent and hard-coded for each operating frequency band. For example, 1.4 megahertz (MHz) for long term evolution (LTE); and 5, 10, or 20 MHz (e.g., subcarrier spacing (SCS) and frequency band dependent) for new radio (NR) frequency range (FR) 1.

In some cases, if a refarmed spectrum has a narrow bandwidth and is scattered in frequency, it may be challenging to leverage such frequency resources for a dynamic spectrum sharing or carrier aggregation (CA). For example, without spectrum aggregation with other CCs to meet a requirement for the minimum CBW of the UE, one or multiple refarmed CCs with a bandwidth of less than 5 MHz may not suitable for stand-alone deployment of NR 5G.

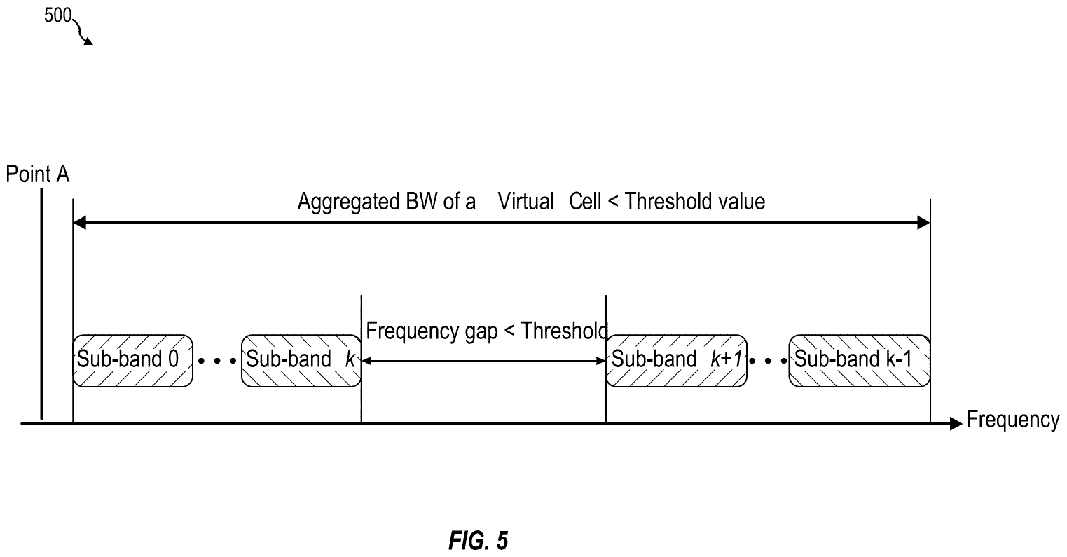

So, in order to overcome the restriction on the spectrum refarming and CA, improve utilization efficiency of fragmented/refarmed resources, and enhance co-existence of different use cases, techniques described herein describe a virtual cell configuration and operation for 6^{th} generation (6G) and beyond. For example, as illustrated in a diagram 500 of FIG. 5, the virtual cell is different from a physical cell (or CC) defined by legacy standards, and may be configured with multiple non-contiguous sub-bands or frequency bands. The virtual cell may include (or is associated with) a lowest frequency associated with a lowest sub-band to a highest frequency associated with a highest sub-band.

In some cases, there may be one or multiple conditions to form the virtual cell, such as: a frequency range (e.g., the virtual cell may contain the multiple sub-bands belonging to a same frequency range), a frequency gap of two adjacent sub-bands (e.g., the frequency gap is less than or equal to a pre-configured/determined threshold), an aggregated bandwidth (e.g., the aggregated bandwidth across all the sub-bands is less than or equal to a pre-configured/determined threshold), a numerology (e.g., all the sub-bands may use a same SCS and cyclic prefix (CP) length), a receive (Rx) timing difference (RTD) (e.g., the RTD of downlink channels/reference signals (RSs) across the sub-bands [T_{MRTD}] is less than pre-configured/determined threshold), a transmit (Tx) timing difference is same for all uplink channels/RSs across the sub-bands, and/Rx power spectral density imbalance between sub-bands is within a pre-configured/determined threshold decibel (dB).

In some cases, a bandwidth part (BWP) is a contiguous set of RBs on a given carrier. The RBs are selected from a contiguous subset of common RBs for a given numerology. Each BWP defined for the numerology may have three different parameters such as a SCS, a symbol duration, and a CP length. The BWP may be allocated for downlink and uplink. For example, a UE may be configured to work with multiple separate downlink BWPs and uplink BWPs for each serving cell.

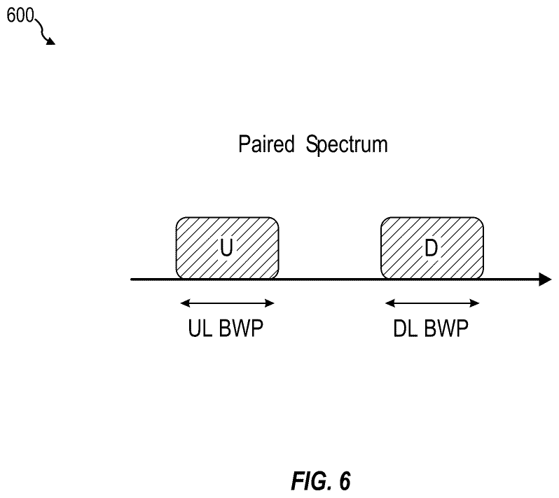

In some cases, a radio spectrum may be organized as paired spectrum, e.g., a block of spectrum in a lower frequency band and an associated block of spectrum in an upper frequency band. This arrangement of frequency bands with one band for uplink and one band for downlink is called the paired spectrum. For example, as illustrated in a diagram 600 of FIG. 6, a downlink BWP may be used for downlink operations and an uplink BWP may be used for uplink operations.

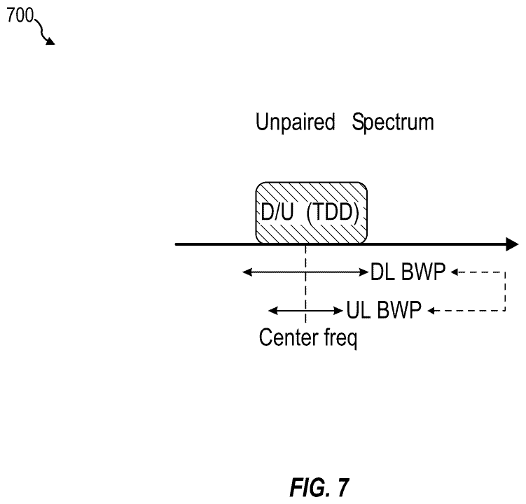

In some cases, unpaired spectrum may be used by transmission technologies using a time division duplexing (TDD), which allows both uplink and downlink to be carried by a same frequency band. For example, as illustrated in a diagram 700 of FIG. 7, for the unpaired spectrum operation, a downlink BWP is linked with an uplink BWP. In such cases, the UE does not expect to receive a configuration where a center frequency for the downlink BWP is different than a center frequency for the uplink BWP.

### Aspects Related to Multi-Band BWP for 6^{th} Generation (6G) Virtual Cell

Aspects of the present disclosure provide apparatuses, methods, processing systems, and computer-readable mediums for configuring uplink and downlink bandwidth parts (BWPs) of a virtual cell.

For example, techniques described herein define configurations of downlink and uplink BWPs for the virtual cell that is formed by multiple frequency bands. For example, downlink sub-bands or uplink sub-bands in the frequency bands for the virtual cell may not always be contiguous. For instance, there may be uplink sub-band(s) in-between downlink sub-bands. A sub-band of a time division duplexing (TDD) frequency band may be a downlink sub-band, an uplink sub-band, or a downlink-uplink switching sub-band.

In some aspects, a user equipment (UE) may not support simultaneous transmit (Tx)-Tx operations and simultaneous Tx-receive (Rx) operations between two sub-bands. The techniques described herein define whether a downlink/uplink BWP may contain such sub-bands. The techniques described herein further define that different sub-bands in the frequency bands for the virtual cell may belong to different frequency bands with different duplex modes and different band characteristics.

Particular aspects of the subject matter described in this disclosure can be implemented to realize one or more of the following potential advantages. In some examples, the described techniques may facilitate new and contiguous spectrum with good coverage and better utilization of frequency resources for downlink/uplink operations.

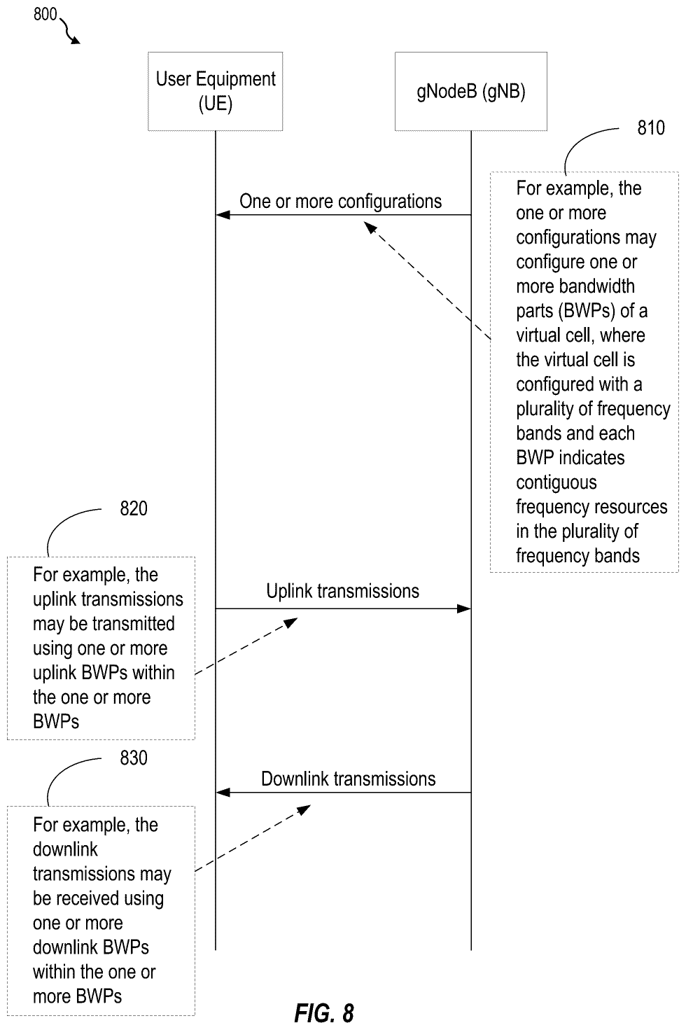

The techniques proposed herein may be understood with reference to FIG. 8-FIG. 19.

FIG. 8 depicts a call flow diagram 800 illustrating example communication among wireless nodes (e.g., a user equipment (UE), a gNodeB (gNB)). The UE shown in FIG. 8 may be an example of the UE 104 depicted and described with respect to FIG. 1 and FIG. 3. The gNB depicted in FIG. 8 may be an example of the BS 102 depicted and described with respect to FIG. 1 and FIG. 3, or the disaggregated BS depicted and described with respect to FIG. 2.

As indicated at 810, the gNB sends one or more configurations to the UE. The one or more configurations may be of one or more BWPs of a virtual cell.

In certain aspects, the virtual cell may be configured with a plurality of frequency bands. The one or more BWPs may include one or more downlink BWPs for reception of one or more downlink transmissions. The one or more BWPs may also include one or more uplink BWPs for transmission of one or more uplink transmissions.

In certain aspects, a BWP of the virtual cell may indicate contiguous frequency resources in one or more of the plurality of frequency bands. In some aspects, the BWP of the virtual cell may indicate the contiguous frequency resources in the plurality of frequency bands. In one example, the contiguous frequency resources may be in non-contiguous frequency bands of the plurality of frequency bands. In another example, the contiguous frequency resources may be in contiguous frequency bands of the plurality of frequency bands.

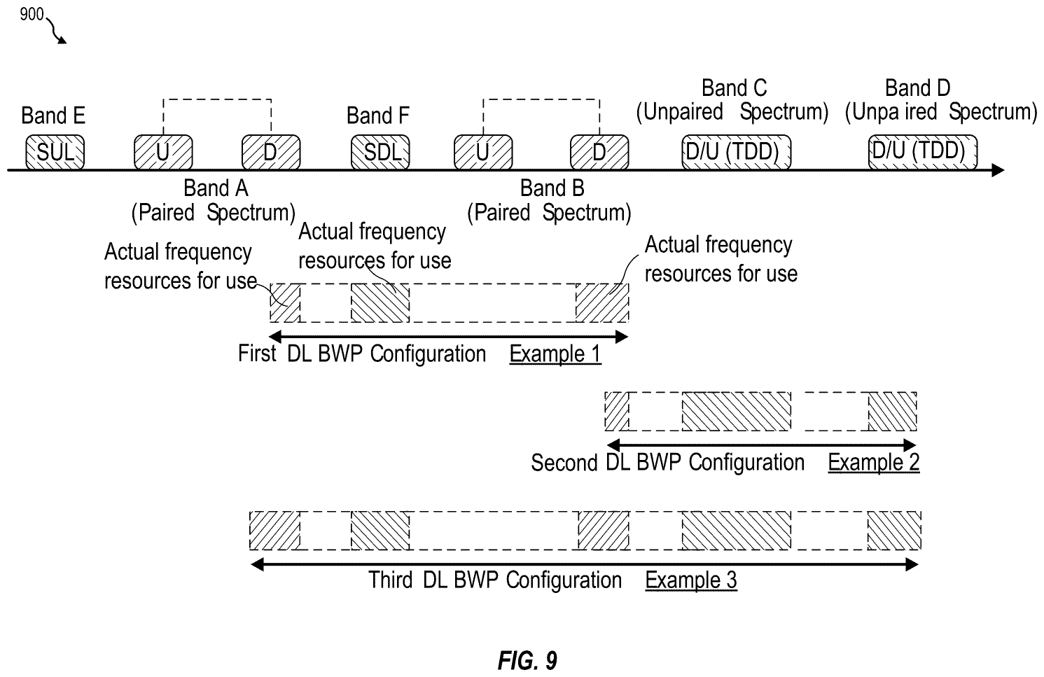

As illustrated in a diagram 900 of FIG. 9, a virtual cell may be configured with multiple frequency bands such as a frequency band A, a frequency band B, a frequency band C, a frequency band D, a frequency band E, and a frequency band F. A BWP in the virtual cell may be defined as contiguous frequencies (e.g., contiguous resource blocks (RBs) with a reference or certain subcarrier spacing (SCS)). The BWP may be a downlink BWP, which may contain a number of contiguous or non-contiguous sub-frequency bands that may enable downlink transmission receptions.

As further illustrated in FIG. 9, a configuration of a first downlink BWP of the virtual cell may include some parts of a downlink spectrum of the frequency band A, all parts of a downlink spectrum of the frequency band F, and all parts of a downlink spectrum of the frequency band B. Actual frequency resources in the first downlink BWP that can be used for downlink communications are also depicted. As further illustrated in FIG. 9, a configuration of a second downlink BWP of the virtual cell may include some parts of a downlink spectrum of the frequency band B, a downlink spectrum of the frequency band C, and a downlink spectrum of the frequency band D. As further illustrated in FIG. 9, a configuration of a third downlink BWP of the virtual cell may include some parts of a downlink spectrum of the frequency band A, a downlink spectrum of the frequency band F, a downlink spectrum of the frequency band B, a downlink spectrum of the frequency band C, and a downlink spectrum of the frequency band D.

Referring back to FIG. 8, as indicated at 820, the UE transmits the one or more uplink transmissions to the gNB. For example, the uplink transmissions may be transmitted using the one or more uplink BWPs within the one or more BWPs associated with the one or more configurations.

As indicated at 830, the UE receives the one or more downlink transmissions from the gNB. For example, the downlink transmissions may be received using the one or more downlink BWPs within the one or more BWPs associated with the one or more configurations.

In some cases, the UE may want to support the virtual cell that may include certain frequency bands (e.g., the frequency band A, the frequency band B). For example, although the frequency band F may be in-between the frequency band A and the frequency band B, the UE may not want to support the frequency band A, the frequency band B, and the frequency band F. In some cases, the gNB may want to configure the virtual cell that may include certain frequency bands (e.g., the frequency band A, the frequency band B). In such cases, prior to configuration of the virtual cell, the UE may report its UE capabilities of a virtual cell formulation to the gNB.

In certain aspects, the UE may transmit capability information indicating one or more sets of frequency bands for the virtual cell to the gNB. Each set of frequency bands may include multiple frequency bands. The plurality of frequency bands of the virtual cell may include at least one of the one or more sets of frequency bands per the capability information of the UE.

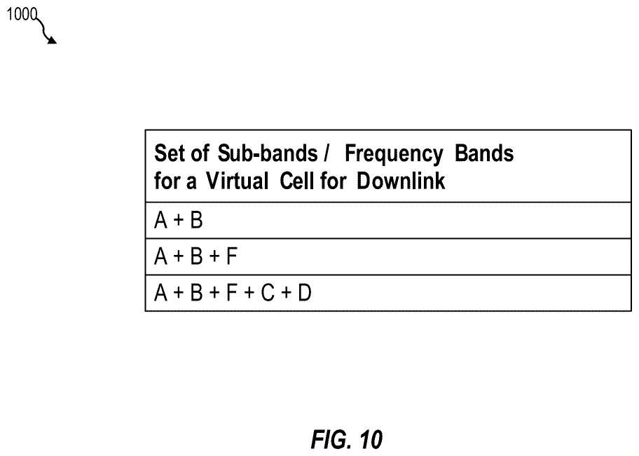

In some examples, the capability information may indicate which set(s) of sub-bands or frequency bands can be in the virtual cell. As illustrated in a table 1000 of FIG. 10, the UE may report multiple sets (e.g., three sets) of sub-bands or frequency bands for the virtual cell, and a sub-band/frequency band may be included in one or multiple sets. The multiple sets may include a first set, a second set, and a third set. The first set may include the frequency band A and the frequency band B. The second set may include the frequency band A, the frequency band B, and the frequency band F. The third set may include the frequency band A, the frequency band B, the frequency band F, the frequency band C, and the frequency band D. The UE may be configured with a BWP of the virtual cell that is formed by one or multiple sub-bands or frequency bands per the capability information. This may be one of supported combination of sub-bands or frequency bands that forms the virtual cell.

In certain aspects, the downlink BWP may indicate a first set of contiguous frequency resources in a first set of frequency bands of the plurality of frequency bands. The uplink BWP may indicate a second set of contiguous frequency resources in a second set of frequency bands of the plurality of frequency bands. At least one frequency band of the first set of frequency bands may be different from at least one frequency band of the second set of frequency bands.

In certain aspects, the UE may transmit capability information indicating the first set of frequency bands (e.g., to be configured for the reception of the one or more downlink transmissions) and the second set of frequency bands (e.g., to be configured for the transmission of the one or more uplink transmissions) to the gNB.

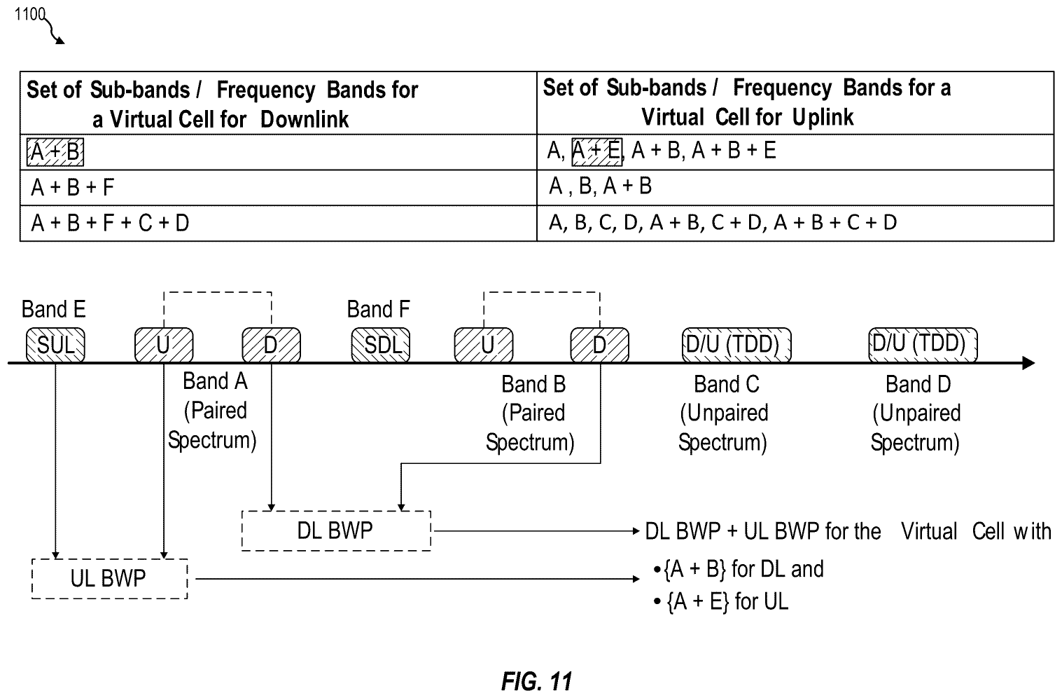

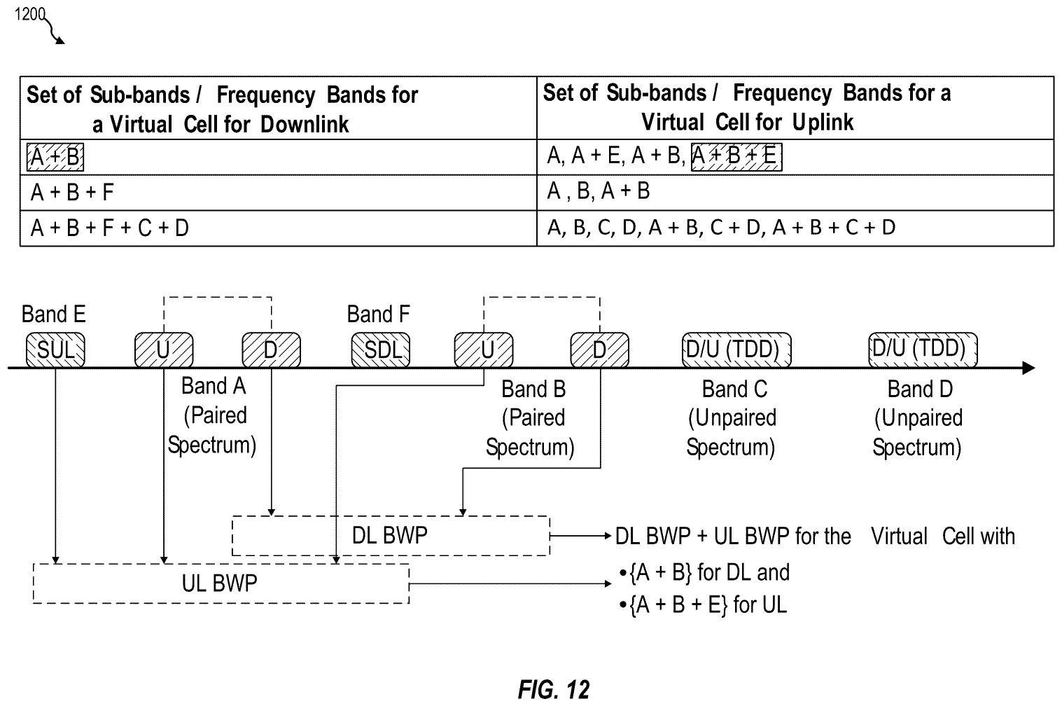

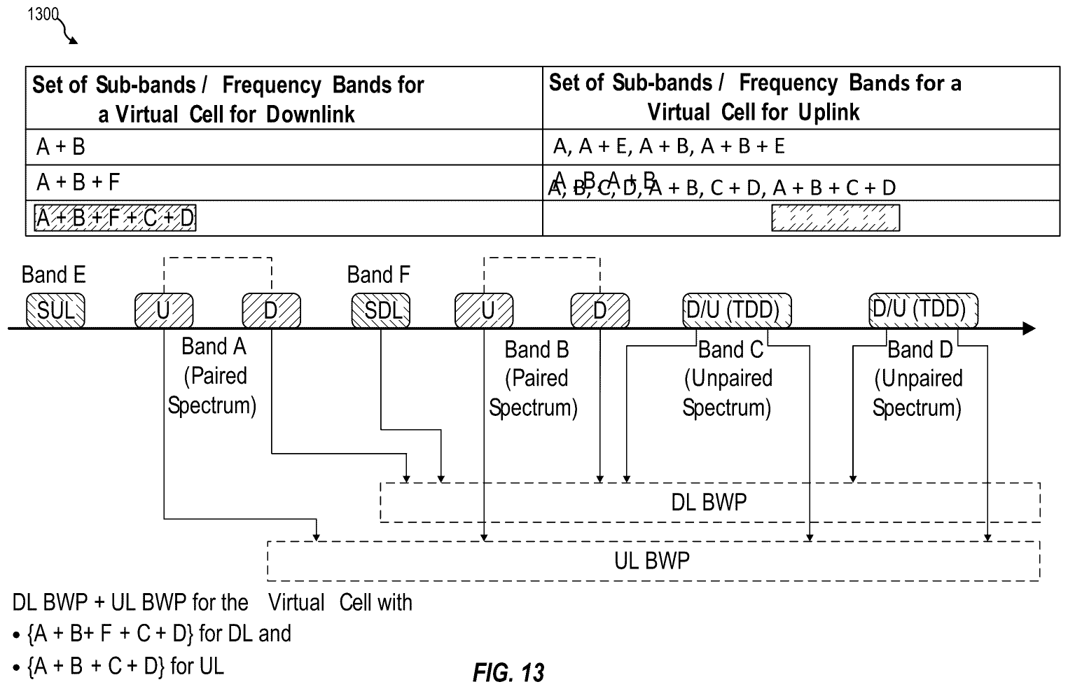

In some examples, a set of sub-bands or frequency bands for downlink for the virtual cell may not need to be the same as that for uplink for the same virtual cell. For example, association between the sub-bands or frequency bands for the downlink and the uplink for the virtual cell are illustrated in FIG. 11, FIG. 12, and FIG. 13.

As illustrated in a diagram 1100 of FIG. 11, a downlink BWP of the virtual cell may be associated with (e.g., at least some or all portions of) the frequency band A and the frequency band B. An uplink BWP of the virtual cell may be associated with (e.g., at least some or all portions of) the frequency band A and the frequency band E.

As illustrated in a diagram 1200 of FIG. 12, a downlink BWP of the virtual cell may be associated with (e.g., at least some or all portions of) the frequency band A and the frequency band B. An uplink BWP of the virtual cell may be associated with (e.g., at least some or all portions of) the frequency band A, the frequency band B, and the frequency band E.

As illustrated in a diagram 1300 of FIG. 13, a downlink BWP of the virtual cell may be associated with (e.g., at least some or all portions of) the frequency band A, the frequency band B, the frequency band F, the frequency band C, and the frequency band D. An uplink BWP of the virtual cell may be associated with (e.g., at least some or all portions of) the frequency band A, the frequency band B, the frequency band C, and the frequency band D.

In some aspects, for a downlink BWP, an uplink BWP, or a pair of downlink BWP and uplink BWP of the virtual cell, the UE may or may not support: simultaneous transmit (Tx)-Tx operations over a set of sub-bands or frequency bands with another set of sub-bands or frequency bands in the uplink BWP, simultaneous receive (Rx)-Rx operations over a set of sub-bands or frequency bands with another set of sub-bands or frequency bands in the downlink BWP, and/or simultaneous Tx-Rx operations over a set of sub-bands or frequency bands in the downlink BWP and a set of sub-bands or frequency bands in the uplink BWP associated with the downlink BWP. In some cases, allowing such restricted multi sub-bands or frequency bands operation of the virtual cell may enable flexible virtual cell configuration over the sub-bands or frequency bands.

In certain aspects, the UE may transmit capability information (e.g., to the gNB) indicating that the UE supports simultaneous uplink transmissions over the second set of frequency bands associated with the uplink BWP. The UE may receive an indication of scheduling of the simultaneous uplink transmissions over the second set of frequency bands associated with the uplink BWP.

In certain aspects, the UE may transmit capability information (e.g., to the gNB) indicating that the UE does not support simultaneous uplink transmissions over the second set of frequency bands associated with the uplink BWP. The UE may receive an indication of scheduling of non-simultaneous uplink transmissions over the second set of frequency bands associated with the uplink BWP.

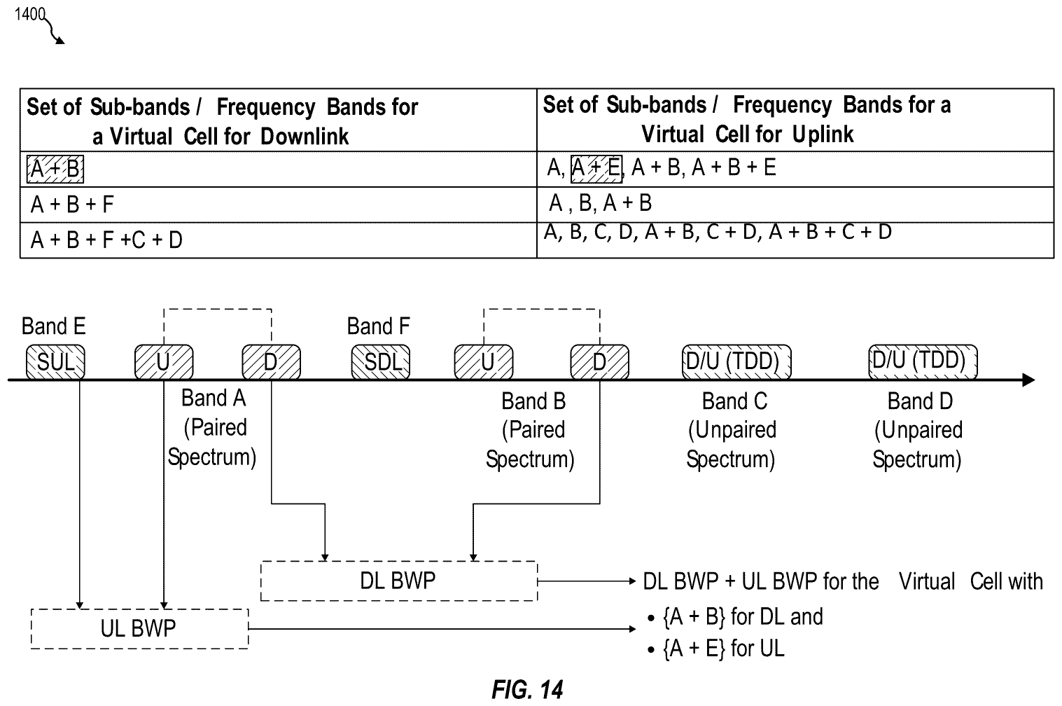

In some examples, for the UL BWP of the virtual cell, the UE may report the capability information indicating whether to support simultaneous Tx-Tx operations over the set of sub-bands or frequency bands with the another set of sub-bands or frequency bands in the uplink BWP. In some cases, the UE may or may not support simultaneous Tx-Tx operations over the frequency band A and the frequency band E in the UL BWP (e.g., as illustrated in a diagram 1400 of FIG. 14).

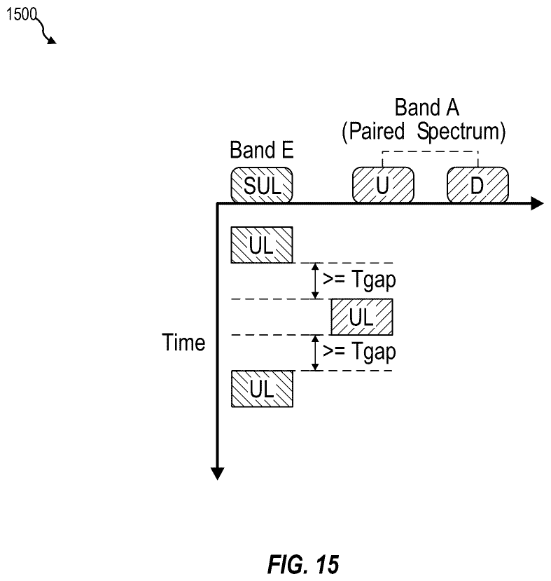

In some examples, when the UE does not support simultaneous Tx-Tx operations over the set of sub-bands or frequency bands, the UE may expect that uplink scheduling or configuration over the set of sub-bands or frequency bands may not be simultaneous. For example, as illustrated in a diagram 1500 of FIG. 15, the UE may be scheduled to transmit uplink transmissions on sub-bands or frequency bands in the UL BWP of the virtual cell with a certain time gap (Tgap) in-between (e.g., same as uplink Tx switching).

In certain aspects, the UE may transmit capability information (e.g., to the gNB) indicating that the UE supports simultaneous reception of downlink transmissions over the first set of frequency bands associated with the downlink BWP. The UE may receive an indication of scheduling of simultaneous downlink transmissions over the first set of frequency bands associated with the downlink BWP.

In certain aspects, the UE may transmit capability information (e.g., to the gNB) indicating that the UE does not support simultaneous reception of downlink transmissions over the first set of frequency bands associated with the downlink BWP. The UE may receive an indication of scheduling of non-simultaneous downlink transmissions over the set of the first set of frequency bands associated with the downlink BWP.

In certain aspects, the UE may transmit capability information (e.g., to the gNB) indicating that the UE supports simultaneous uplink transmission and reception of a downlink transmission over the second set of frequency bands associated with the uplink

BWP and the first set of frequency bands associated with the downlink BWP. The UE may receive an indication of scheduling of the simultaneous uplink transmission and the downlink transmission over the second set of frequency bands associated with the uplink BWP and the first set of frequency bands associated with the downlink BWP.

In certain aspects, the UE may transmit capability information (e.g., to the gNB) indicating that the UE does not support simultaneous uplink transmission and reception of a downlink transmission over the second set of frequency bands associated with the uplink BWP and the first set of frequency bands associated with the downlink BWP. The UE may receive an indication of scheduling of non-simultaneous uplink transmission and the downlink transmission over the second set of frequency bands associated with the uplink BWP and the first set of frequency bands associated with the downlink BWP.

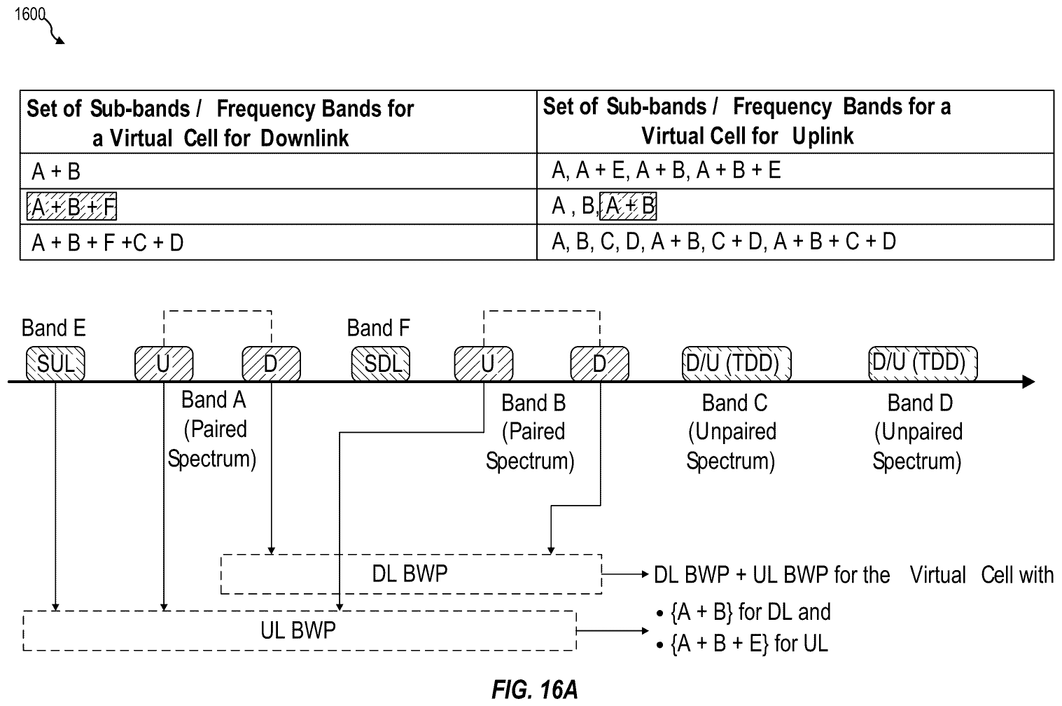

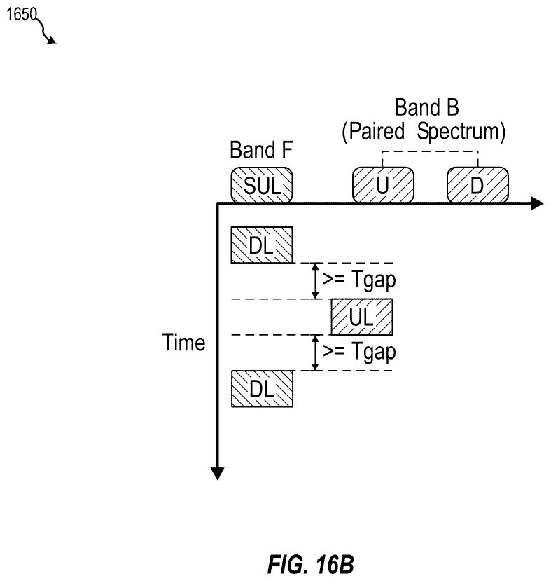

In some examples, for a pair of downlink BWP and uplink BWP of the virtual cell, the UE may report the capability information indicating simultaneous Tx-Rx operations over a set of sub-bands or frequency bands in the downlink BWP and a set of sub-bands or frequency bands in the uplink BWP associated with the downlink BWP. In some cases, the UE may or may not support simultaneous Tx-Rx operations over the frequency band F (e.g., in the downlink BWP) and the frequency band B (e.g., in uplink BWP) (e.g., as illustrated in a diagram 1600 of FIG. 16A).

In some examples, when the UE does not support simultaneous Tx-Rx operations over the set of sub-bands or frequency bands, the UE may expect that uplink and downlink scheduling or configuration over the set of sub-bands or frequency bands may not be simultaneous. For example, as illustrated in a diagram 1650 of FIG. 16B, the UE may be scheduled to transmit uplink and downlink transmissions on sub-bands or frequency bands with a certain time gap (Tgap) in-between (e.g., same as half duplex frequency division duplex (FDD) or time division duplex (TDD) operations).

In certain aspects, a first configuration of the downlink BWP and a second configuration of the uplink BWP are constant and do not vary with time. For example, a TDD sub-band or frequency band may be time-varying downlink/uplink sub-band. For example, the downlink BWP and the uplink BWP may be constant and do not time-vary, even if it includes the TDD sub-band or frequency band.

In certain aspects, a first configuration of the downlink BWP and a second configuration of the uplink BWP vary with time (e.g., depending on downlink or uplink of the containing TDD sub-band/frequency band). For example, the downlink BWP or the uplink BWP are time-varying depending on downlink or uplink portion of a TDD sub-band or frequency band. In one aspect, the time varying of the downlink BWP or the uplink BWP may be based on a semi-static configuration, e.g., due to downlink or uplink in TDD uplink-downlink configuration of sub-bands C/D. In another aspect, the time varying of the downlink BWP or the uplink BWP may be based on a dynamic indication, e.g., downlink/uplink scheduling for a dynamic TDD in sub-bands C/D.

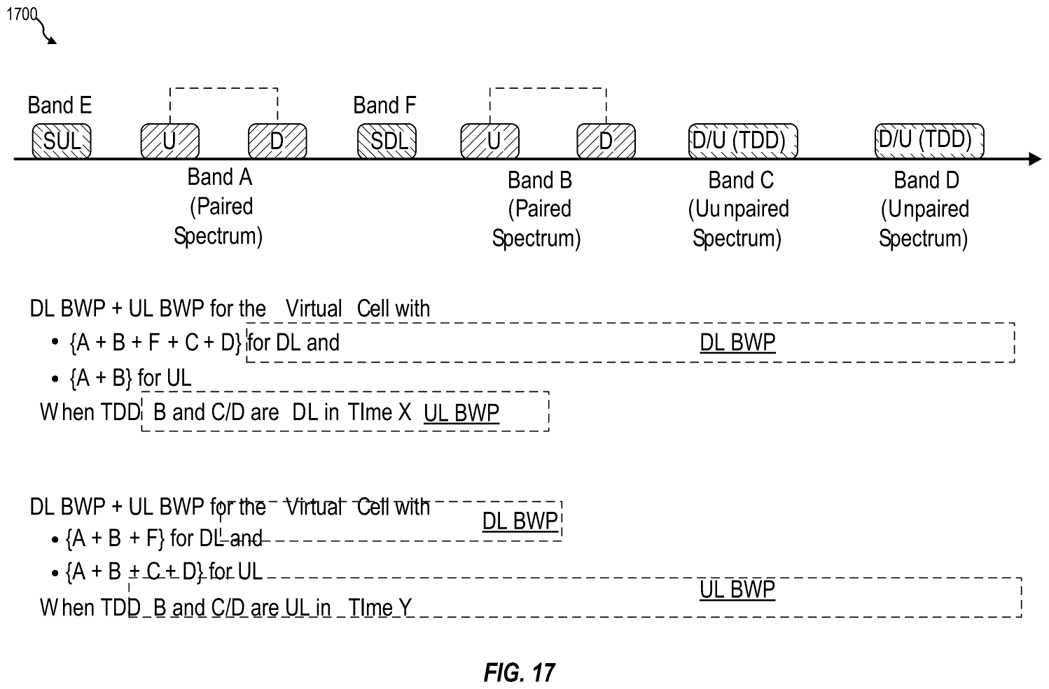

For example, as illustrated in a diagram 1700 of FIG. 17, the downlink BWP and/or the uplink BWP are associated with different frequency bands at time X and at time Y. For instance, at time X: the downlink BWP is associated with the frequency band A, the frequency band B, the frequency band F, the frequency band C, the frequency band D; and the uplink BWP is associated with the frequency band A and the frequency band B. At another time Y: the downlink BWP is associated with the frequency band A, the frequency band B, the frequency band F; and the uplink BWP is associated with the frequency band A, the frequency band B, the frequency band C, the frequency band D.

### Example Method for Wireless Communications

FIG. 18 shows an example of a method 1800 for wireless communications at a wireless node. The wireless node may be a user equipment (UE), such as the UE 104 of FIG. 1 and FIG. 3.

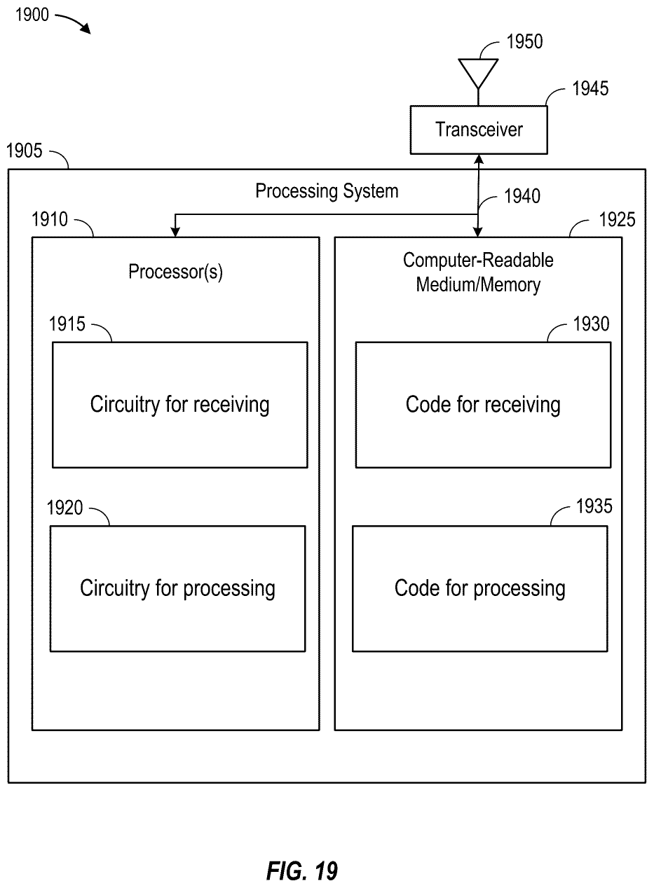

Method 1800 begins at 1810 with receiving one or more configurations of one or more bandwidth parts (BWPs) of a virtual cell. The virtual cell is configured with a plurality of frequency bands and each BWP indicates contiguous frequency resources in the plurality of frequency bands. In some cases, the operations of this step refer to, or may be performed by, circuitry for receiving and/or code for receiving as described with reference to FIG. 19.

Method 1800 then proceeds to 1820 with processing one or more transmissions, in accordance with the received configurations. In some cases, the operations of this step refer to, or may be performed by, circuitry for processing and/or code for processing as described with reference to FIG. 19.

In certain aspects, the contiguous frequency resources are in non-contiguous frequency bands of the plurality of frequency bands.

In certain aspects, the one or more BWPs comprise at least one of: a downlink BWP for reception of one or more downlink transmissions, or an uplink BWP for transmission of one or more uplink transmissions.

In certain aspects, the method 1800 further includes transmitting capability information indicating one or more sets of frequency bands for the virtual cell, wherein each set of frequency bands comprises multiple frequency bands. In some cases, some of the operations of this step refer to, or may be performed by, circuitry for transmitting and/or code for transmitting as described with reference to FIG. 19. In some cases, some of the operations of this step refer to, or may be performed by, circuitry for receiving and/or code for receiving as described with reference to FIG. 19.

In certain aspects, the plurality of frequency bands of the virtual cell comprise one of the one or more sets of frequency bands.

In certain aspects, the one or more BWPs comprise a downlink BWP for reception of one or more downlink transmissions and an uplink BWP for transmission of one or more uplink transmissions; the downlink BWP indicates a first set of contiguous frequency resources in a first set of frequency bands of the plurality of frequency bands; the uplink BWP indicates a second set of contiguous frequency resources in a second set of frequency bands of the plurality of frequency bands; and at least one frequency band of the first set of frequency bands is different from at least one frequency band of the second set of frequency bands.

In certain aspects, the method 1800 further includes transmitting capability information indicating the first set of frequency bands to be configured for the reception of the one or more downlink transmissions and the second set of frequency bands to be configured for the transmission of the one or more uplink transmissions. In some cases, the operations of this step refer to, or may be performed by, circuitry for transmitting and/or code for transmitting as described with reference to FIG. 19.

In certain aspects, the method 1800 further includes transmitting capability information indicating that the UE supports simultaneous uplink transmissions over the second set of frequency bands associated with the uplink BWP; and receiving an indication of scheduling of the simultaneous uplink transmissions over the second set of frequency bands associated with the uplink BWP. In some cases, some of the operations of this step refer to, or may be performed by, circuitry for transmitting and/or code for transmitting as described with reference to FIG. 19. In some cases, some of the operations of this step refer to, or may be performed by, circuitry for receiving and/or code for receiving as described with reference to FIG. 19.

In certain aspects, the method 1800 further includes transmitting capability information indicating that the UE does not support simultaneous uplink transmissions over the second set of frequency bands associated with the uplink BWP; and receiving an indication of scheduling of non-simultaneous uplink transmissions over the second set of frequency bands associated with the uplink BWP. In some cases, some of the operations of this step refer to, or may be performed by, circuitry for transmitting and/or code for transmitting as described with reference to FIG. 19. In some cases, some of the operations of this step refer to, or may be performed by, circuitry for receiving and/or code for receiving as described with reference to FIG. 19.

In certain aspects, the method 1800 further includes transmitting capability information indicating that the UE supports simultaneous reception of downlink transmissions over the first set of frequency bands associated with the downlink BWP; and receiving an indication of scheduling of simultaneous downlink transmissions over the first set of frequency bands associated with the downlink BWP. In some cases, some of the operations of this step refer to, or may be performed by, circuitry for transmitting and/or code for transmitting as described with reference to FIG. 19. In some cases, some of the operations of this step refer to, or may be performed by, circuitry for receiving and/or code for receiving as described with reference to FIG. 19.

In certain aspects, the method 1800 further includes transmitting capability information indicating that the UE does not support simultaneous reception of downlink transmissions over the first set of frequency bands associated with the downlink BWP; and receiving an indication of scheduling of non-simultaneous downlink transmissions over the set of the first set of frequency bands associated with the downlink BWP. In some cases, some of the operations of this step refer to, or may be performed by, circuitry for transmitting and/or code for transmitting as described with reference to FIG. 19. In some cases, some of the operations of this step refer to, or may be performed by, circuitry for receiving and/or code for receiving as described with reference to FIG. 19.

In certain aspects, the method 1800 further includes transmitting capability information indicating that the UE supports simultaneous uplink transmission and reception of a downlink transmission over the second set of frequency bands associated with the uplink BWP and the first set of frequency bands associated with the downlink BWP; and receiving an indication of scheduling of the simultaneous uplink transmission and the downlink transmission over the second set of frequency bands associated with the uplink BWP and the first set of frequency bands associated with the downlink BWP. In some cases, some of the operations of this step refer to, or may be performed by, circuitry for transmitting and/or code for transmitting as described with reference to FIG. 19. In some cases, some of the operations of this step refer to, or may be performed by, circuitry for receiving and/or code for receiving as described with reference to FIG. 19.

In certain aspects, the method 1800 further includes transmitting capability information indicating that the UE does not support simultaneous uplink transmission and reception of a downlink transmission over the second set of frequency bands associated with the uplink BWP and the first set of frequency bands associated with the downlink BWP; and receiving an indication of scheduling of non-simultaneous uplink transmission and the downlink transmission over the second set of frequency bands associated with the uplink BWP and the first set of frequency bands associated with the downlink BWP. In some cases, some of the operations of this step refer to, or may be performed by, circuitry for transmitting and/or code for transmitting as described with reference to FIG. 19. In some cases, some of the operations of this step refer to, or may be performed by, circuitry for receiving and/or code for receiving as described with reference to FIG. 19.

In certain aspects, a first configuration of the downlink BWP and a second configuration of the uplink BWP are constant and do not vary with time.

In certain aspects, a first configuration of the downlink BWP and a second configuration of the uplink BWP vary with time.

In one aspect, the method 1800, or any aspect related to it, may be performed by an apparatus, such as a communications device 1900 of FIG. 19, which includes various components operable, configured, or adapted to perform the method 1800. The communications device 1900 is described below in further detail.

Note that FIG. 18 is just one example of a method, and other methods including fewer, additional, or alternative steps are possible consistent with this disclosure.

### Example Communications Device

FIG. 19 depicts aspects of an example communications device 1900. In some aspects, the communications device 1900 may be a user equipment (UE), such as UE 104 described above with respect to FIG. 1 and FIG. 3.

The communications device 1900 includes a processing system 1905 coupled to a transceiver 1945 (e.g., a transmitter and/or a receiver). The transceiver 1945 is configured to transmit and receive signals for the communications device 1900 via an antenna 1950, such as the various signals as described herein. The processing system 1905 may be configured to perform processing functions for the communications device 1900, including processing signals received and/or to be transmitted by the communications device 1900.

The processing system 1905 includes one or more processors 1910. In various aspects, the one or more processors 1910 may be representative of one or more of receive processor 358, transmit processor 364, TX MIMO processor 366, and/or controller/processor 380, as described with respect to FIG. 3. The one or more processors 1910 are coupled to a computer-readable medium/memory 1925 via a bus 1940. In certain aspects, the computer-readable medium/memory 1925 is configured to store instructions (e.g., computer-executable code) that when executed by the one or more processors 1910, cause the one or more processors 1910 to perform the method 1800 described with respect to FIG. 18, and/or any aspect related to it. Note that reference to a processor performing a function of communications device 1900 may include the one or more processors 1910 performing that function of communications device 1900.

In the depicted example, computer-readable medium/memory 1925 stores code (e.g., executable instructions), such as code for receiving (or obtaining) 1930, code for processing 1935 and/or code for transmitting (or outputting). Processing of the code for receiving 1930, the code for processing 1935 and/or the code for transmitting may cause the communications device 1900 to perform the method 1800 described with respect to FIG. 18, and/or any aspect related to it.

The one or more processors 1910 include circuitry configured to implement (e.g., execute) the code stored in the computer-readable medium/memory 1925, including circuitry such as circuitry for receiving (or obtaining) 1915, circuitry for processing 1920, and/or circuitry for transmitting (or outputting). Processing with the circuitry for receiving 1915, the circuitry for processing 1920, and/or the circuitry for transmitting may cause the communications device 1900 to perform the method 1800 described with respect to FIG. 18, and/or any aspect related to it.

Various components of the communications device 1900 may provide means for performing the method 1800 described with respect to FIG. 18, and/or any aspect related to it.

For example, means for transmitting, sending or outputting (e.g., for transmission) may include transceivers 354 and/or antenna(s) 352 of the UE 104 illustrated in FIG. 3 and/or the code for transmitting, the circuitry for transmitting, the transceiver 1945 and the antenna 1950 of the communications device 1900 in FIG. 19. Means for receiving or obtaining may include transceivers 354 and/or antenna(s) 352 of the UE 104 illustrated in FIG. 3 and/or the code for receiving 1930, the circuitry for receiving 1915, the transceiver 1945 and the antenna 1950 of the communications device 1900 in FIG. 19. Means for processing may include processors, transceivers 354 and/or antenna(s) 352 of the UE 104 illustrated in FIG. 3 and/or the code for processing 1935, the circuitry for processing 1920, the transceiver 1945 and the antenna 1950 of the communications device 1900 in FIG. 19.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 19 is an example, and many other examples and configurations of communication device 1900 are possible.

### EXAMPLE CLAUSES

Implementation examples are described in the following numbered clauses:
Clause 1: A method for wireless communications at a user equipment (UE), comprising: receiving one or more configurations of one or more bandwidth parts (BWPs) of a virtual cell, wherein the virtual cell is configured with a plurality of frequency bands and each BWP indicates contiguous frequency resources in the plurality of frequency bands; and processing one or more transmissions, in accordance with the received configurations.
Clause 2: The method of clause 1, wherein the contiguous frequency resources are in non-contiguous frequency bands of the plurality of frequency bands.
Clause 3: The method of any one of clauses 1-2, wherein the one or more BWPs comprise at least one of: a downlink BWP for reception of one or more downlink transmissions, or an uplink BWP for transmission of one or more uplink transmissions.
Clause 4: The method of any one of clauses 1-3, further comprising transmitting capability information indicating one or more sets of frequency bands for the virtual cell, wherein each set of frequency bands comprises multiple frequency bands.
Clause 5: The method of clause 4, wherein the plurality of frequency bands of the virtual cell comprise one of the one or more sets of frequency bands.
Clause 6: The method of any one of clauses 1-5, wherein: the one or more BWPs comprise a downlink BWP for reception of one or more downlink transmissions and an uplink BWP for transmission of one or more uplink transmissions; the downlink BWP indicates a first set of contiguous frequency resources in a first set of frequency bands of the plurality of frequency bands; the uplink BWP indicates a second set of contiguous frequency resources in a second set of frequency bands of the plurality of frequency bands; and at least one frequency band of the first set of frequency bands is different from at least one frequency band of the second set of frequency bands.
Clause 7: The method of clause 6, further comprising transmitting capability information indicating the first set of frequency bands to be configured for the reception of the one or more downlink transmissions and the second set of frequency bands to be configured for the transmission of the one or more uplink transmissions.
Clause 8: The method of clause 6, further comprising: transmitting capability information indicating that the UE supports simultaneous uplink transmissions over the second set of frequency bands associated with the uplink BWP; and receiving an indication of scheduling of the simultaneous uplink transmissions over the second set of frequency bands associated with the uplink BWP.
Clause 9: The method of clause 6, further comprising: transmitting capability information indicating that the UE does not support simultaneous uplink transmissions over the second set of frequency bands associated with the uplink BWP; and receiving an indication of scheduling of non-simultaneous uplink transmissions over the second set of frequency bands associated with the uplink BWP.
Clause 10: The method of clause 6, further comprising: transmitting capability information indicating that the UE supports simultaneous reception of downlink transmissions over the first set of frequency bands associated with the downlink BWP; and receiving an indication of scheduling of simultaneous downlink transmissions over the first set of frequency bands associated with the downlink BWP.
Clause 11: The method of clause 6, further comprising: transmitting capability information indicating that the UE does not support simultaneous reception of downlink transmissions over the first set of frequency bands associated with the downlink BWP; and receiving an indication of scheduling of non-simultaneous downlink transmissions over the set of the first set of frequency bands associated with the downlink BWP.
Clause 12: The method of clause 6, further comprising: transmitting capability information indicating that the UE supports simultaneous uplink transmission and reception of a downlink transmission over the second set of frequency bands associated with the uplink BWP and the first set of frequency bands associated with the downlink BWP; and receiving an indication of scheduling of the simultaneous uplink transmission and the downlink transmission over the second set of frequency bands associated with the uplink BWP and the first set of frequency bands associated with the downlink BWP.
Clause 13: The method of clause 6, further comprising: transmitting capability information indicating that the UE does not support simultaneous uplink transmission and reception of a downlink transmission over the second set of frequency bands associated with the uplink BWP and the first set of frequency bands associated with the downlink BWP; and receiving an indication of scheduling of non-simultaneous uplink transmission and the downlink transmission over the second set of frequency bands associated with the uplink BWP and the first set of frequency bands associated with the downlink BWP.
Clause 14: The method of clause 6, wherein a first configuration of the downlink BWP and a second configuration of the uplink BWP are constant and do not vary with time.
Clause 15: The method of clause 6, wherein a first configuration of the downlink BWP and a second configuration of the uplink BWP vary with time.
Clause 16: An apparatus, comprising: a memory comprising instructions; and one or more processors configured, individually or in any combination, to execute the instructions and cause the apparatus to perform a method in accordance with any one of Clauses 1-15.
Clause 17: An apparatus, comprising means for performing a method in accordance with any one of Clauses 1-15.
Clause 18: A non-transitory computer-readable medium comprising executable instructions that, when executed by one or more processors of an apparatus, cause the apparatus to perform a method in accordance with any one of Clauses 1-15.
Clause 19: A computer program product embodied on a computer-readable storage medium comprising code for performing a method in accordance with any one of Clauses 1-15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term wireless node may refer to, for example, a network entity or a UE. In this context, a network entity may be a base station (e.g., a gNB) or a module (e.g., a CU, DU, and/or RU) of a disaggregated base station.

While the present disclosure may describe certain operations as being performed by one type of wireless node, the same or similar operations may also be performed by another type of wireless node. For example, operations performed by a network entity may also (or instead) be performed by a UE. Similarly, operations performed by a UE may also (or instead) be performed by a network entity.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
at least one memory comprising instructions; and
one or more processors, individually or collectively, configured to execute the instructions and cause the apparatus to:
receive one or more configurations of one or more bandwidth parts (BWPs) of a virtual cell, wherein the virtual cell is configured with a plurality of frequency bands and each BWP indicates contiguous frequency resources in the plurality of frequency bands; and
process one or more transmissions, in accordance with the received configurations.

2. The apparatus of claim 1, wherein the contiguous frequency resources are in non-contiguous frequency bands of the plurality of frequency bands.

3. The apparatus of claim 1, wherein the one or more BWPs comprise at least one of:
a downlink BWP for reception of one or more downlink transmissions, or
an uplink BWP for transmission of one or more uplink transmissions.

4. The apparatus of claim 1, wherein the one or more processors, individually or collectively, are configured to execute the instructions and cause the apparatus to transmit capability information indicating one or more sets of frequency bands for the virtual cell, wherein each set of frequency bands comprises multiple frequency bands.

5. The apparatus of claim 4, wherein the plurality of frequency bands of the virtual cell comprise one of the one or more sets of frequency bands.

6. The apparatus of claim 1, wherein:
the one or more BWPs comprise a downlink BWP for reception of one or more downlink transmissions and an uplink BWP for transmission of one or more uplink transmissions;
the downlink BWP indicates a first set of contiguous frequency resources in a first set of frequency bands of the plurality of frequency bands;
the uplink BWP indicates a second set of contiguous frequency resources in a second set of frequency bands of the plurality of frequency bands; and
at least one frequency band of the first set of frequency bands is different from at least one frequency band of the second set of frequency bands.

7. The apparatus of claim 6, wherein the one or more processors, individually or collectively, are configured to execute the instructions and cause the apparatus to transmit capability information indicating the first set of frequency bands to be configured for the reception of the one or more downlink transmissions and the second set of frequency bands to be configured for the transmission of the one or more uplink transmissions.

8. The apparatus of claim 6, wherein the one or more processors, individually or collectively, are configured to execute the instructions and cause the apparatus to:
transmit capability information indicating that the UE supports simultaneous uplink transmissions over the second set of frequency bands associated with the uplink BWP; and
receive an indication of scheduling of the simultaneous uplink transmissions over the second set of frequency bands associated with the uplink BWP.

9. The apparatus of claim 6, wherein the one or more processors, individually or collectively, are configured to execute the instructions and cause the apparatus to:
transmit capability information indicating that the UE does not support simultaneous uplink transmissions over the second set of frequency bands associated with the uplink BWP; and
receive an indication of scheduling of non-simultaneous uplink transmissions over the second set of frequency bands associated with the uplink BWP.

10. The apparatus of claim 6, wherein the one or more processors, individually or collectively, are configured to execute the instructions and cause the apparatus to:
transmit capability information indicating that the UE supports simultaneous reception of downlink transmissions over the first set of frequency bands associated with the downlink BWP; and
receive an indication of scheduling of simultaneous downlink transmissions over the first set of frequency bands associated with the downlink BWP.

11. The apparatus of claim 6, wherein the one or more processors, individually or collectively, are configured to execute the instructions and cause the apparatus to:
transmit capability information indicating that the UE does not support simultaneous reception of downlink transmissions over the first set of frequency bands associated with the downlink BWP; and
receive an indication of scheduling of non-simultaneous downlink transmissions over the set of the first set of frequency bands associated with the downlink BWP.

12. The apparatus of claim 6, wherein the one or more processors, individually or collectively, are configured to execute the instructions and cause the apparatus to:
transmit capability information indicating that the UE supports simultaneous uplink transmission and reception of a downlink transmission over the second set of frequency bands associated with the uplink BWP and the first set of frequency bands associated with the downlink BWP; and
receive an indication of scheduling of the simultaneous uplink transmission and the downlink transmission over the second set of frequency bands associated with the uplink BWP and the first set of frequency bands associated with the downlink BWP.

13. The apparatus of claim 6, wherein the one or more processors, individually or collectively, are configured to execute the instructions and cause the apparatus to:
transmit capability information indicating that the UE does not support simultaneous uplink transmission and reception of a downlink transmission over the second set of frequency bands associated with the uplink BWP and the first set of frequency bands associated with the downlink BWP; and
receive an indication of scheduling of non-simultaneous uplink transmission and the downlink transmission over the second set of frequency bands associated with the uplink BWP and the first set of frequency bands associated with the downlink BWP.

14. The apparatus of claim 6, wherein a first configuration of the downlink BWP and a second configuration of the uplink BWP are constant and do not vary with time.

15. The apparatus of claim 6, wherein a first configuration of the downlink BWP and a second configuration of the uplink BWP vary with time.

16. A method for wireless communications at a user equipment (UE), comprising:
receiving one or more configurations of one or more bandwidth parts (BWPs) of a virtual cell, wherein the virtual cell is configured with a plurality of frequency bands and each BWP indicates contiguous frequency resources in the plurality of frequency bands; and
processing one or more transmissions, in accordance with the received configurations.

17. The method of claim 16, wherein the contiguous frequency resources are in non-contiguous frequency bands of the plurality of frequency bands.

18. The method of claim 16, wherein the one or more BWPs comprise at least one of:
a downlink BWP for reception of one or more downlink transmissions, or
an uplink BWP for transmission of one or more uplink transmissions.

19. A non-transitory computer-readable medium comprising computer-executable instructions that, when executed by one or more processors of a user equipment (UE), cause the UE to perform a method of wireless communications, comprising:
receiving one or more configurations of one or more bandwidth parts (BWPs) of a virtual cell, wherein the virtual cell is configured with a plurality of frequency bands and each BWP indicates contiguous frequency resources in the plurality of frequency bands; and
processing one or more transmissions, in accordance with the received configurations.

20. The non-transitory computer-readable medium of claim 19, wherein the contiguous frequency resources are in non-contiguous frequency bands of the plurality of frequency bands.
